(19) United States
(12) Patent Application Publication
(10) Pub. No.: US 2013/0176717 A1
(43) Pub. Date: Jul. 11, 2013

(54) Detachable Cover Apparatus For Compact Fluorescent Light (CFL) Bulbs That Affects Illumination Clarity, Quality, and Color

(71) Applicant: Hooshmand Harooni, Los Angeles, CA (US)

(72) Inventor: Hooshmand Harooni, Los Angeles, CA (US)

(21) Appl. No.: 13/346,238

(22) Filed: Jan. 9, 2012

(51) Int. Cl. F21V 11/00

(52) U.S. Cl. 362/217.08

(57) ABSTRACT

This invention describes a makeup applicator device with a built-in, portable light source that can be moved closer to the point of makeup application while the makeup is being applied. (hereinafter “Makeup Applicator with Moveable Light Source”). This apparatus provides a small battery powered LED light source built into either the applicator wand itself or into the outside casing of the applicator device. The light source is brought closer to the application point by either moving the light source closer to the point where the makeup contacts the human subject, or alternatively by moving the applicator itself closer to a stationary light source. The movements described herein are accomplished either by a twist motion on the applicator cap or a small sliding mechanism built into the cap itself.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

In view of the foregoing, this Makeup Applicator with Moveable Light Source device described in this application provides for an applicator device with a built-in, portable light source that can be moved closer to the point of makeup application while the makeup is being applied to provide maximum illumination in low light conditions. Alternatively, as described in the Claims portion of this application, in an alternate embodiment, the applicator itself is moveable closer or farther away from the built-in portable LED light source to achieve the same result.

The need for makeup application in low light conditions is a common problem. Whether the issue is caused by night time conditions or with low ambient light inside of a building structure such as a restaurant, there is a need to illuminate the specific area around the point where the makeup is being applied, so as to allow application of the makeup to be done accurately and easily. This Makeup Applicator with Moveable Light Source solves this problem by providing a built-in LED light within the applicator itself, which illuminates when the cap with attached applicator is removed from the base makeup “bottle” holding the makeup liquid. Once illuminated, multiple mechanisms can be employed to move the LED light source closer to the point of application in order to illuminate the target area where the makeup is being applied, Thus, this invention allows the human subject to accurately and easily apply the makeup even in low light conditions.

The Makeup Applicator with Moveable Light. Source can be built in several different variations, some examples of which are provided below:
(a) An embodiment where using a twisting type action on the end of the applicator cap, an LED light source embedded within the hollow tube of the applicator portion attached to the applicator tip moves closer to and farther away from the makeup application point.
(b) An embodiment where using a twisting type action on the end of the applicator cap, an LED light source attached to the lengthwise axis of the applicator cap, on the opposite end from the twisting end of the cap, moves closer to and farther away from the makeup application point.
(c) An embodiment where using a twisting type action on the end of the applicator cap, the applicator portion with the attached applicator tip moves closer to and farther away from the makeup application point. In this embodiment the applicator tube and tip moves closer to and farther away from the LED light source that is attached to the lengthwise axis of the applicator cap, on the opposite end from the twisting end of the cap, and the LED light source remains stationary.
(d) An embodiment where using a sliding type action on the exterior and along the longitudinal axis of the applicator cap, an LED light source embedded within the hollow tube of the applicator wand portion attached to the applicator tip moves closer to and farther away from the makeup application point.
(e) An embodiment where using a sliding type action on the exterior and along the longitudinal axis of the applicator cap, an LED light source attached to the lengthwise axis of the applicator cap, on the end closest to the applicator tip, moves closer to and farther away from the makeup application point.
(f) An embodiment where using a sliding type action on the exterior and along the longitudinal axis of the applicator cap, the applicator portion with the attached applicator tip moves closer to and farther away from the makeup application point. In this embodiment the applicator tube and tip moves closer to and farther away from the LED light source that is attached to the lengthwise axis of the applicator cap, on the opposite end from the twisting end of the cap, and the applicator tip remains stationary.

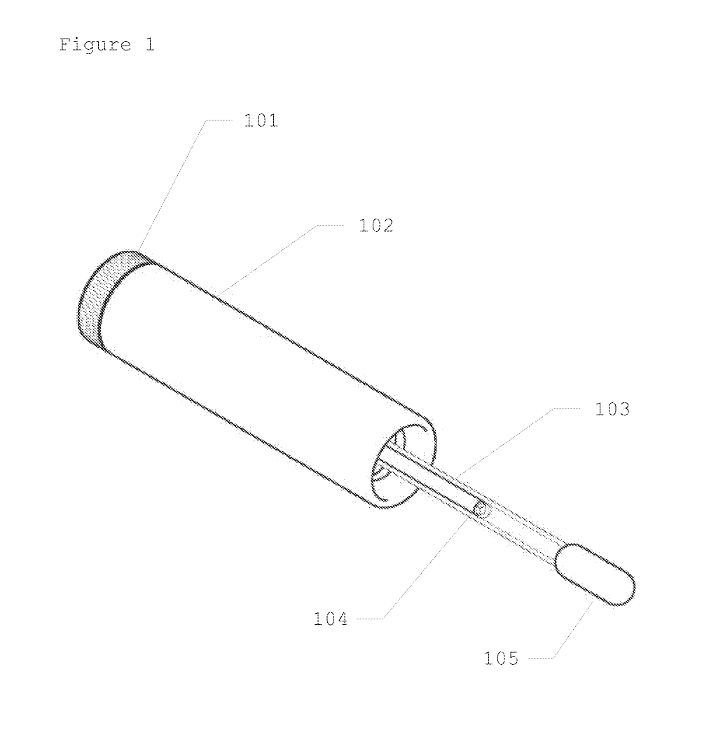

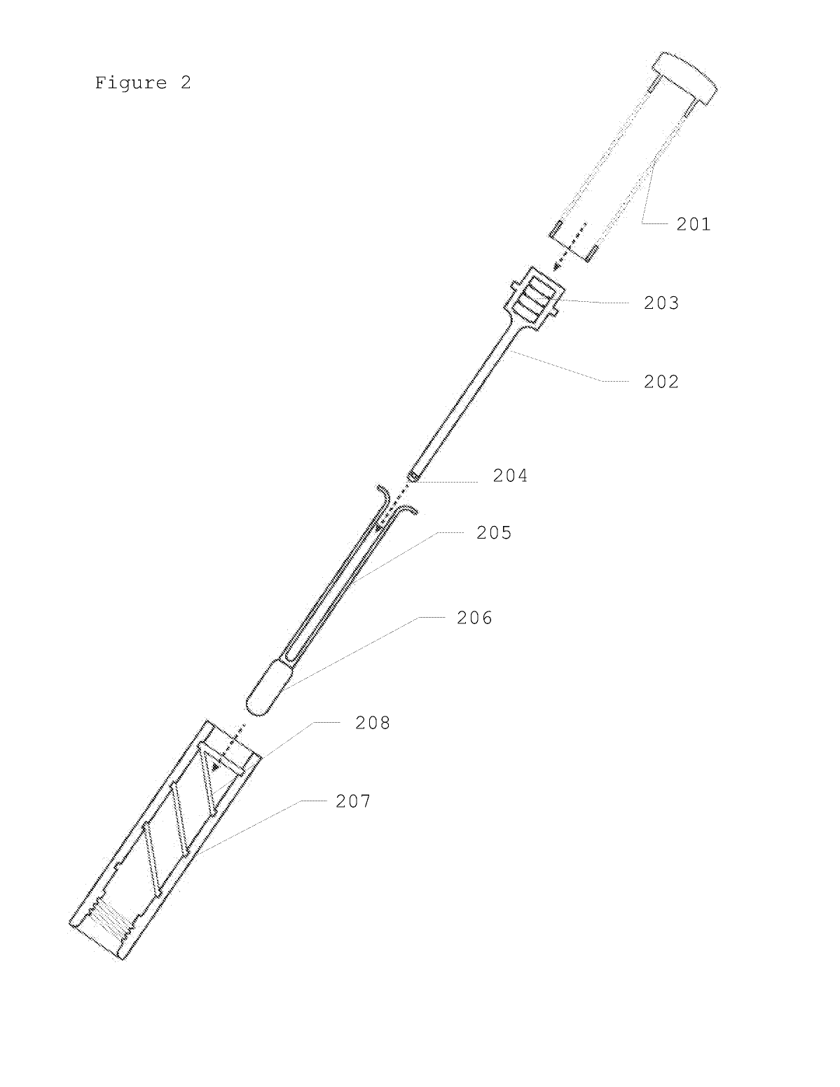

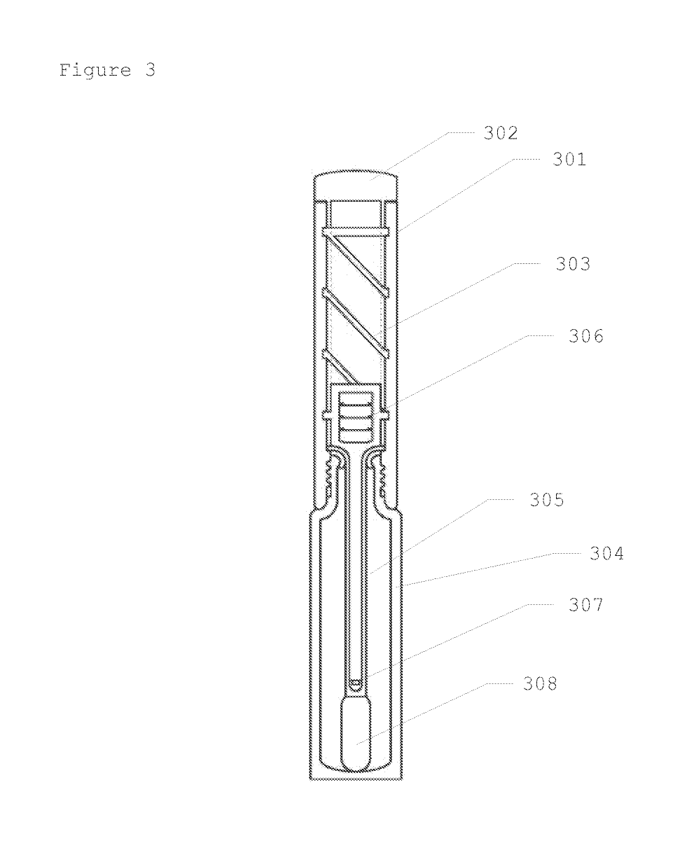

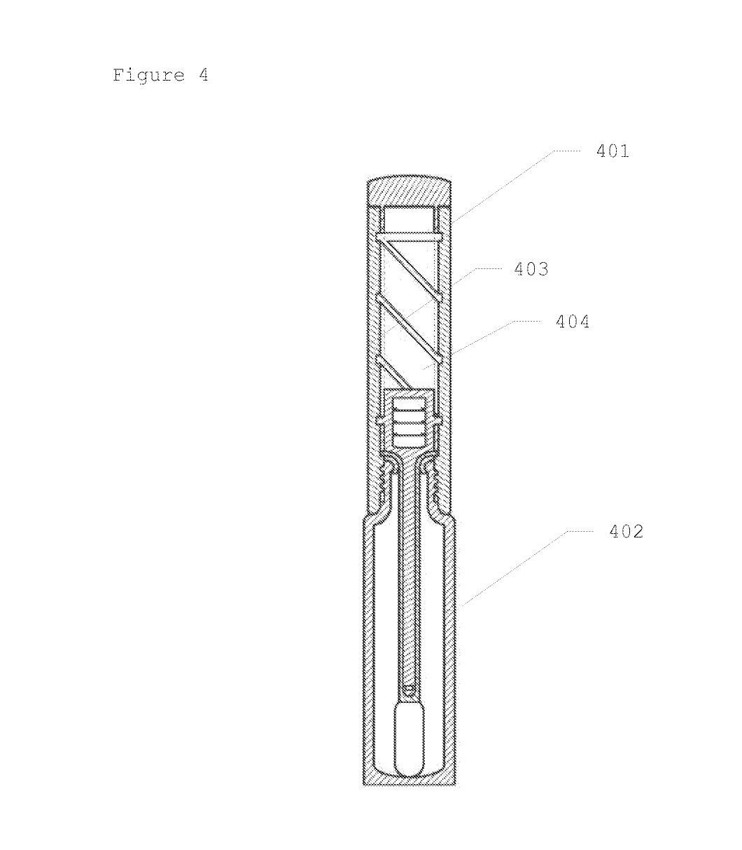

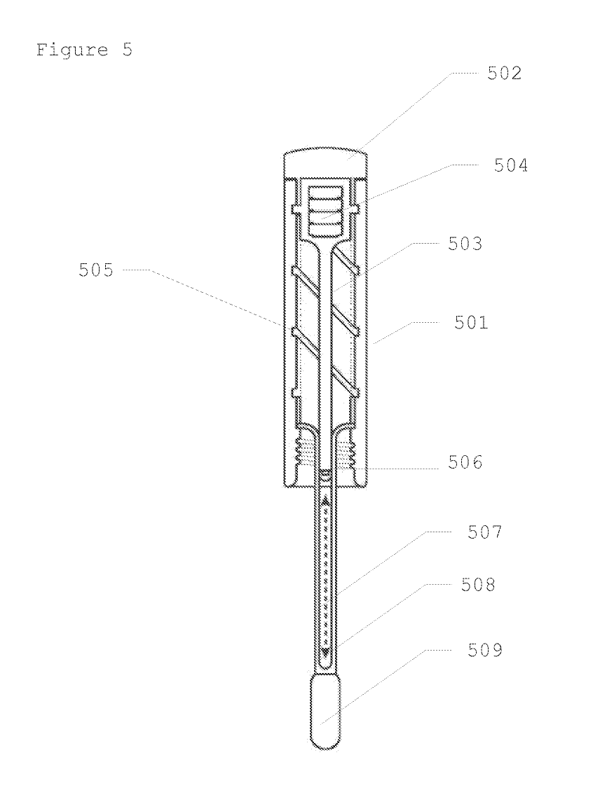

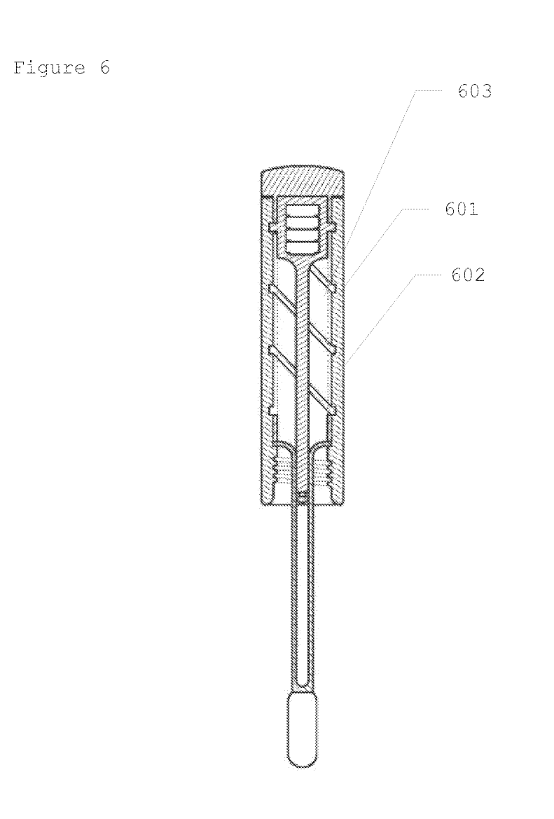

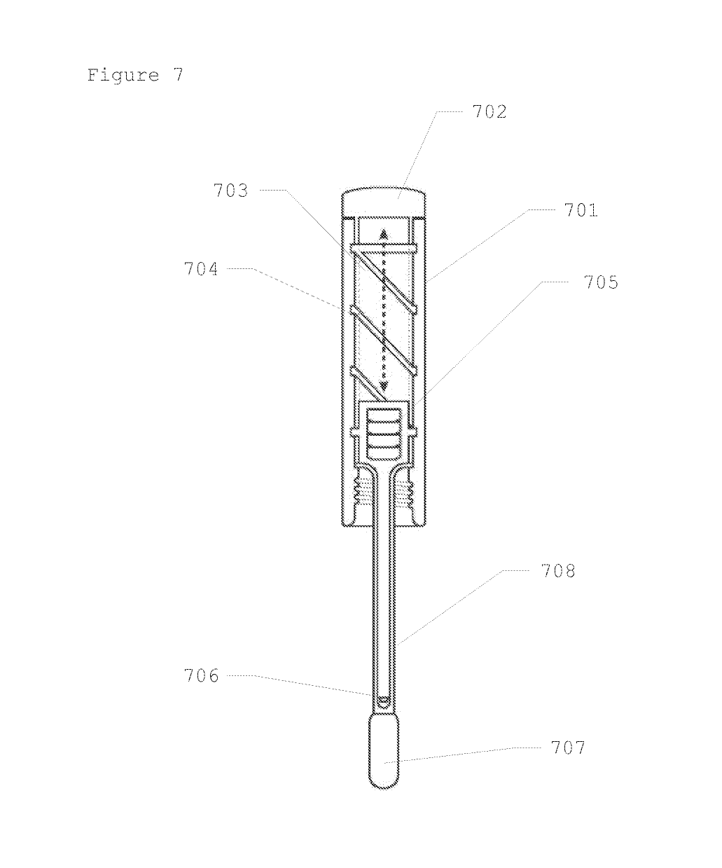

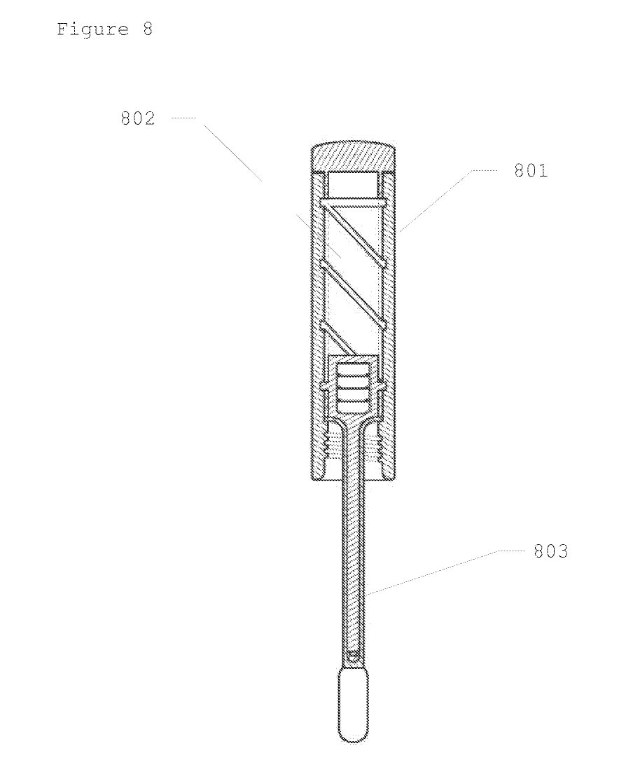

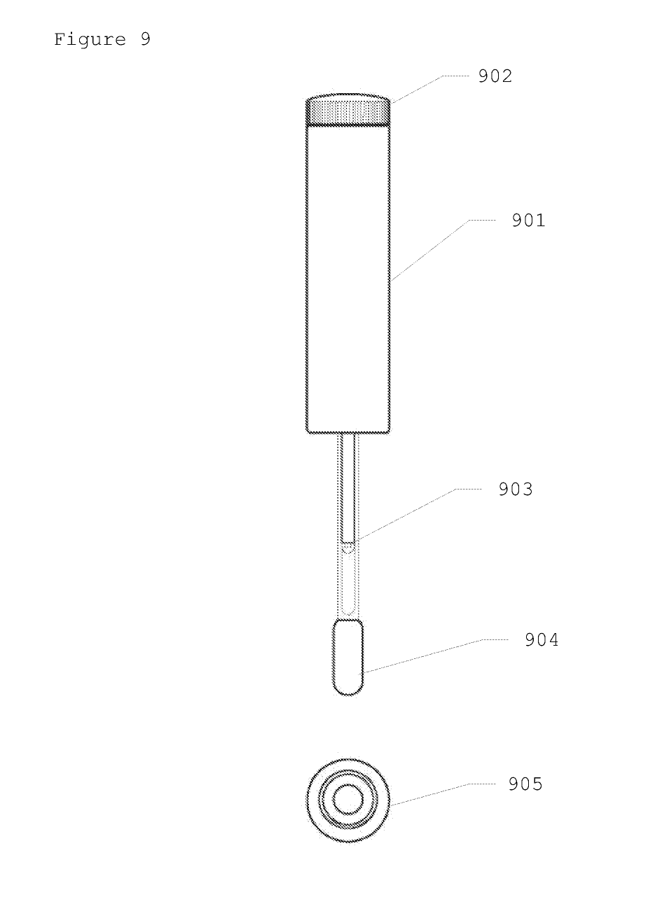

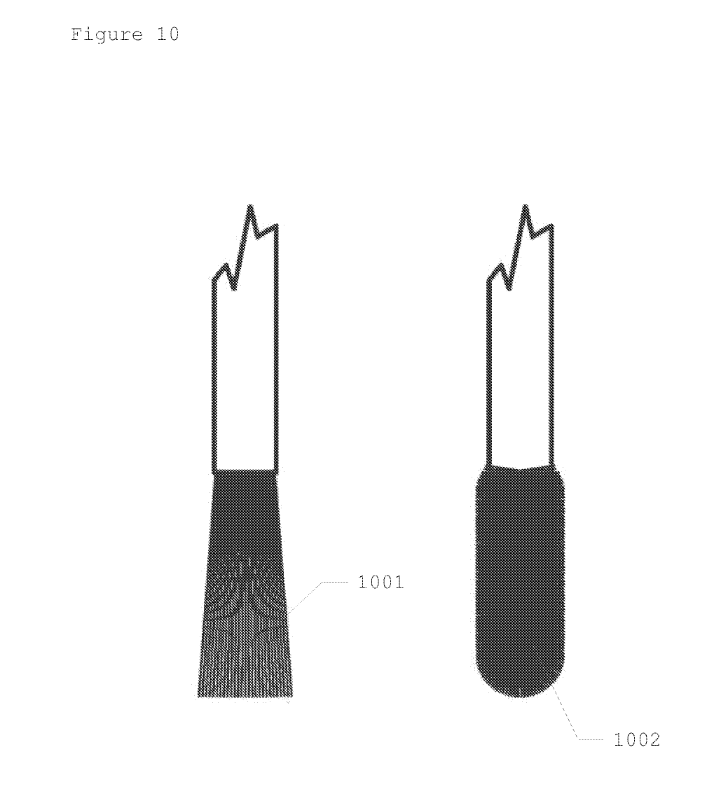

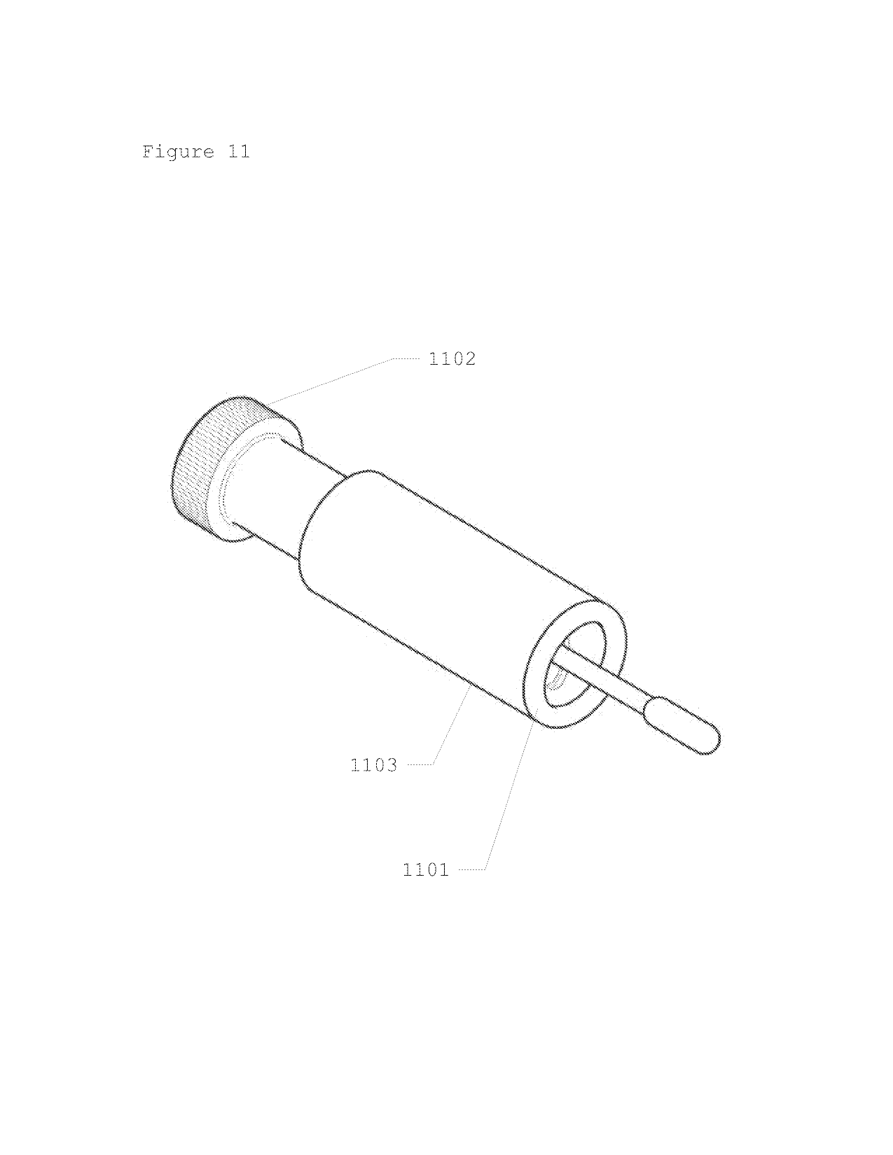

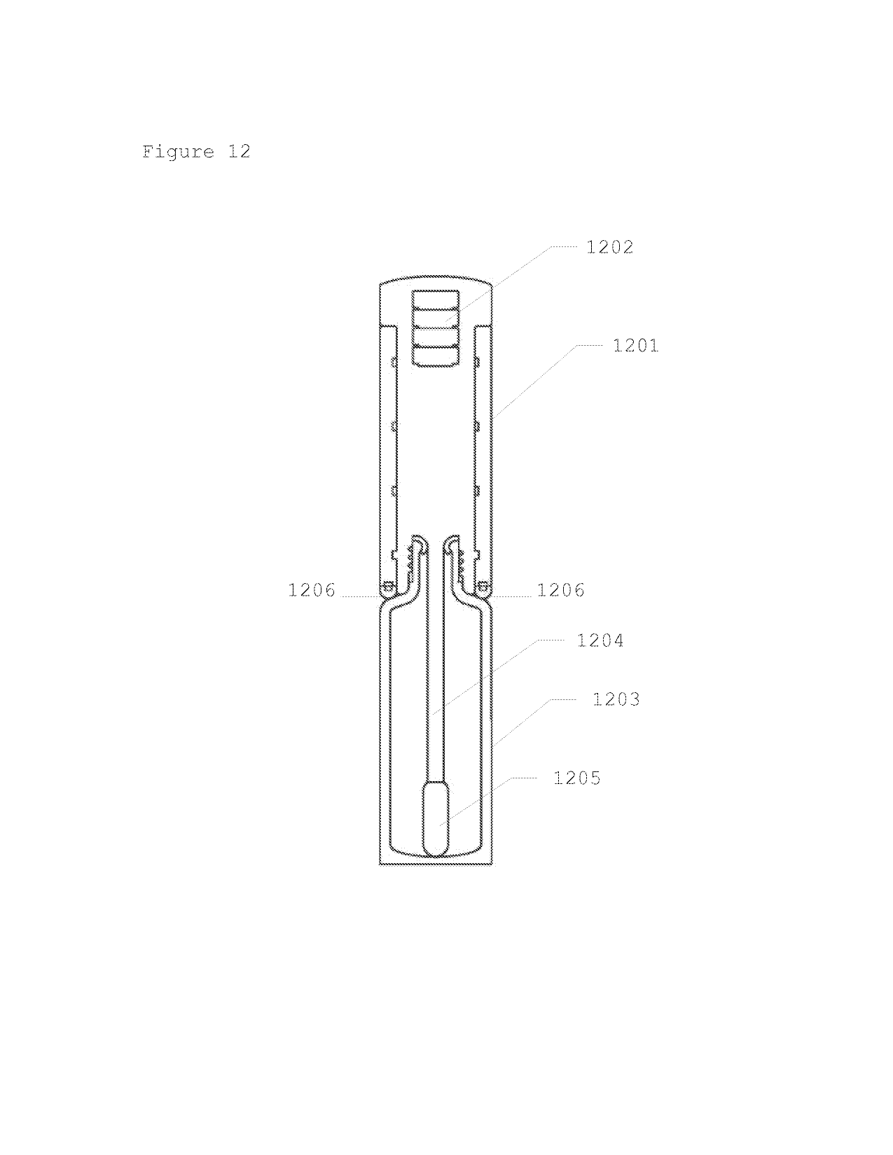

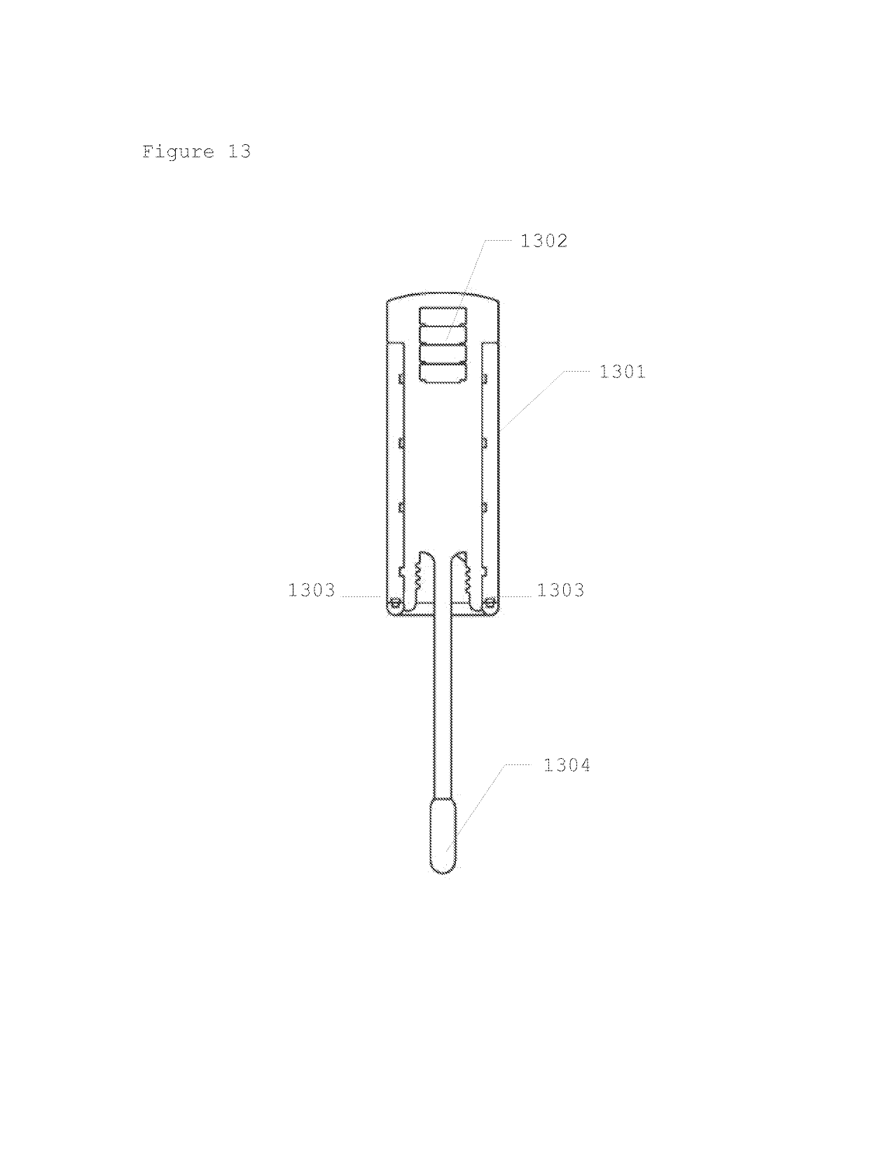

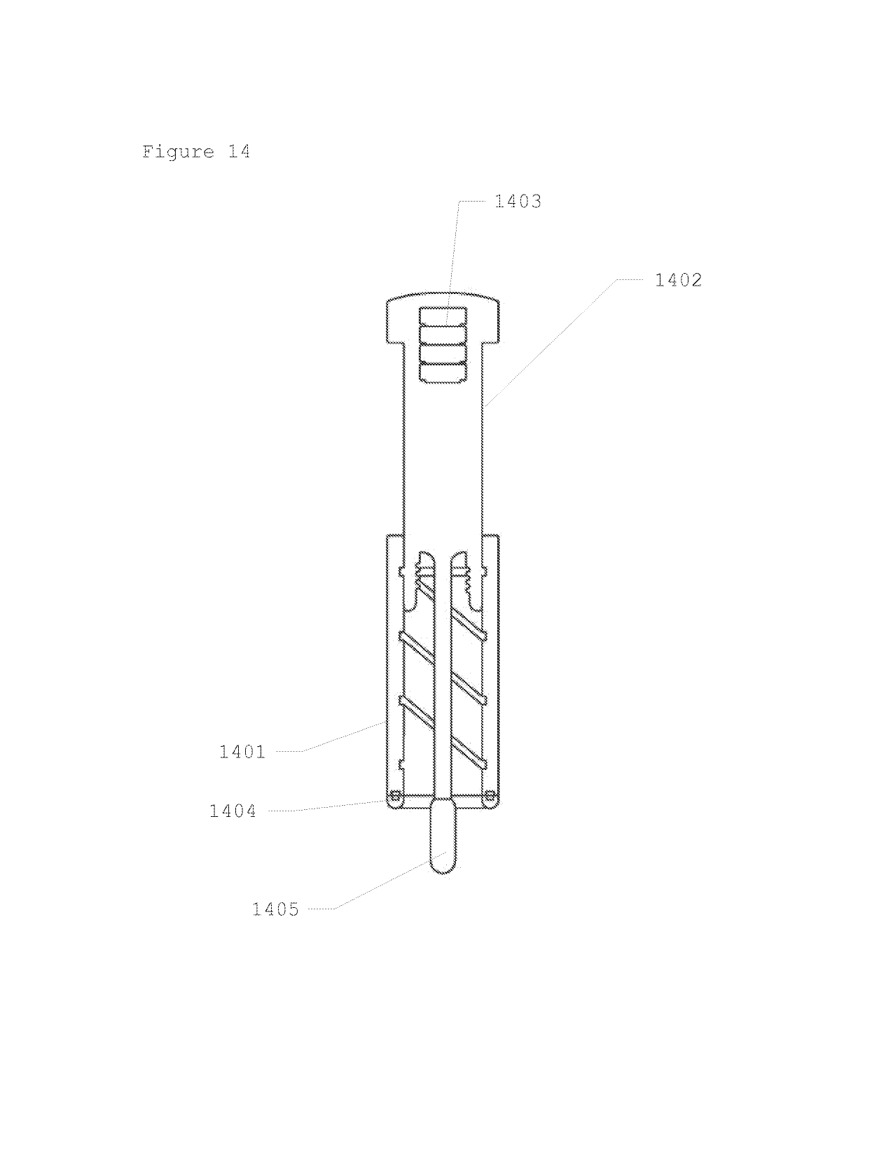

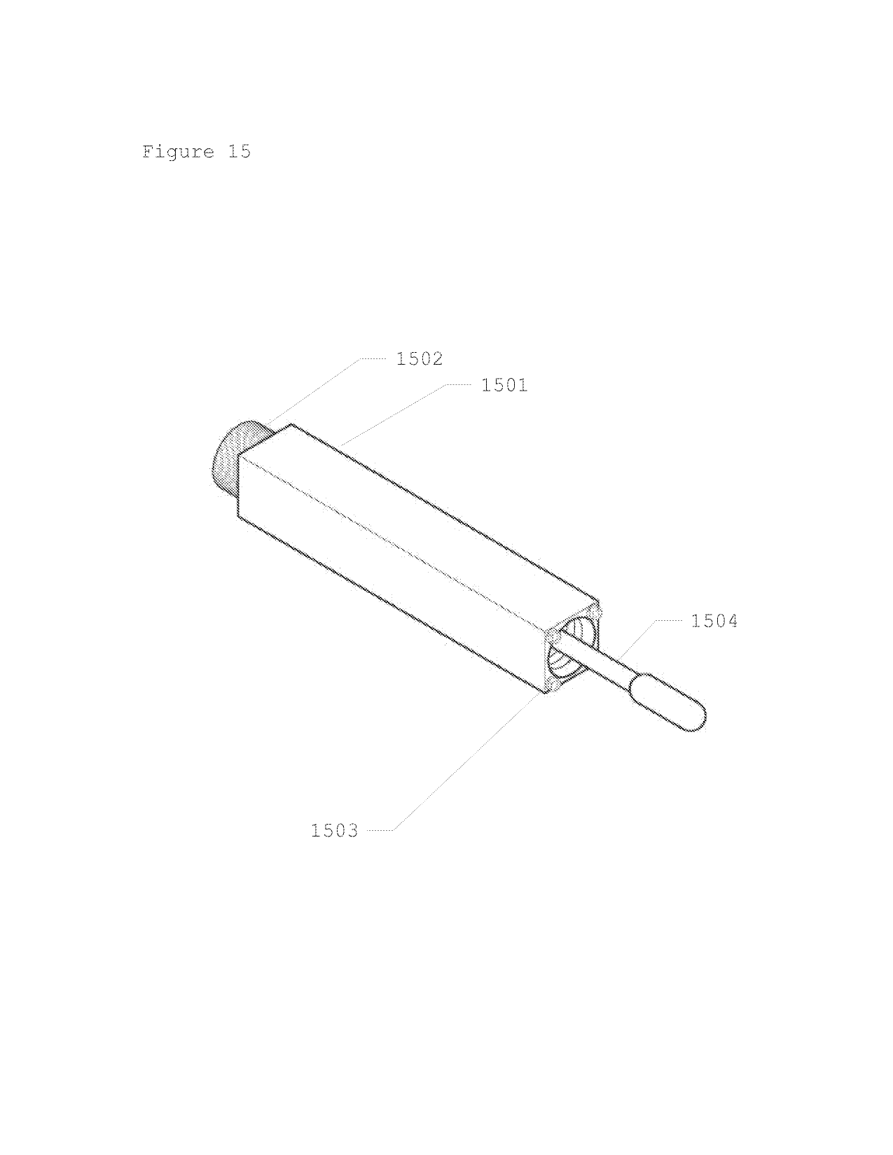

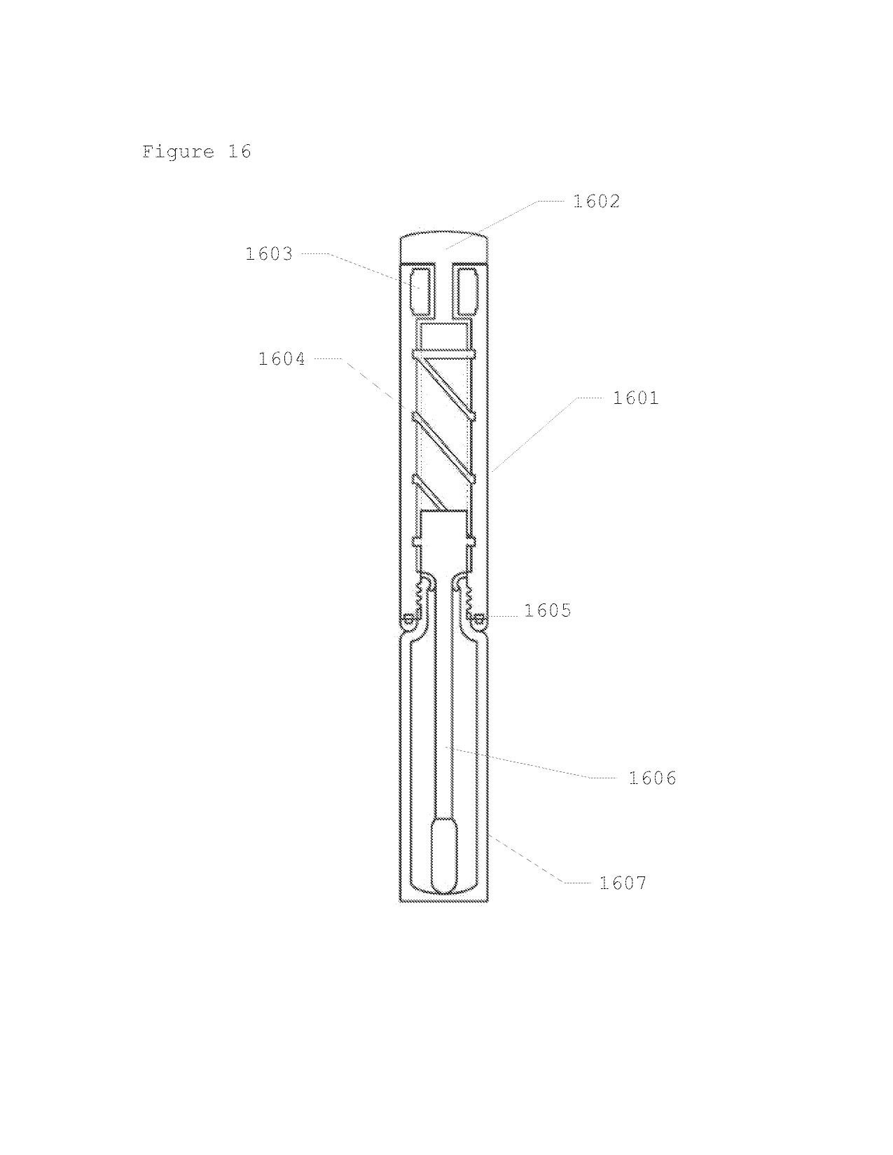

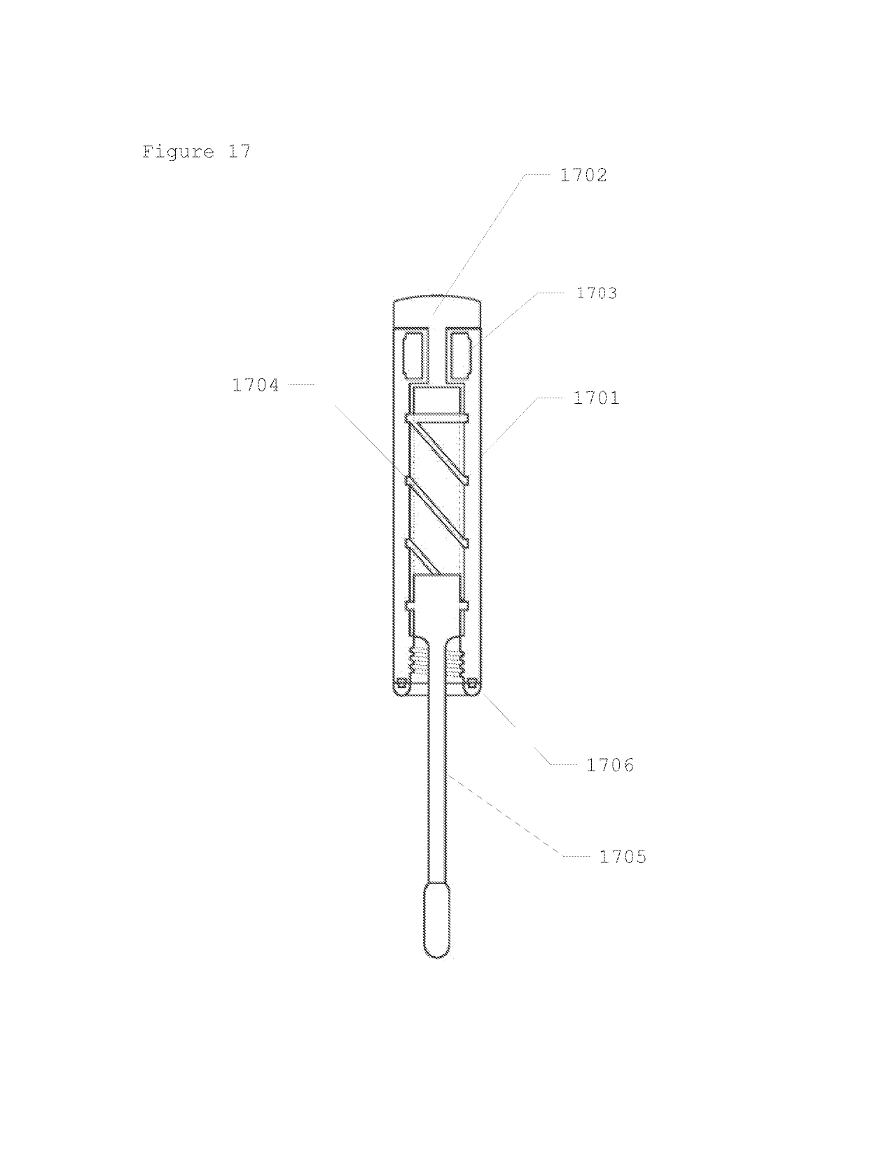

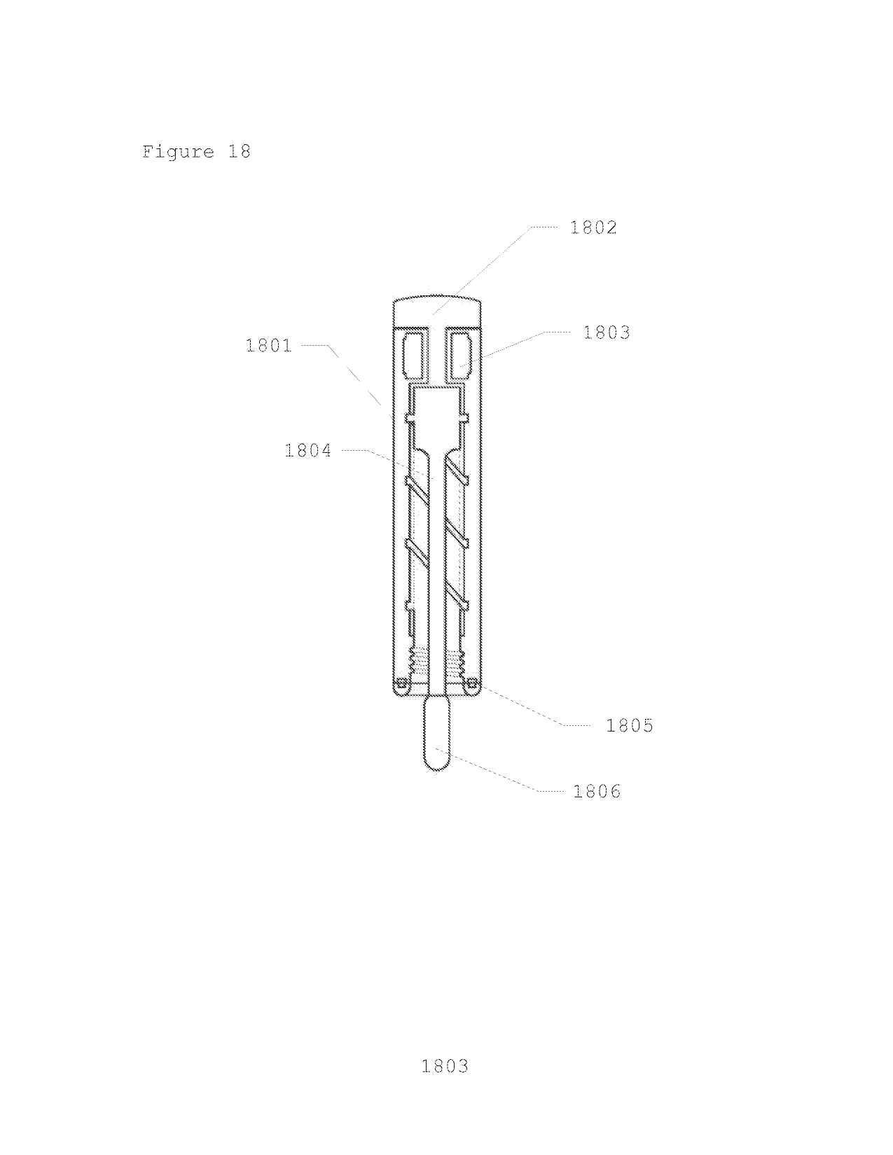

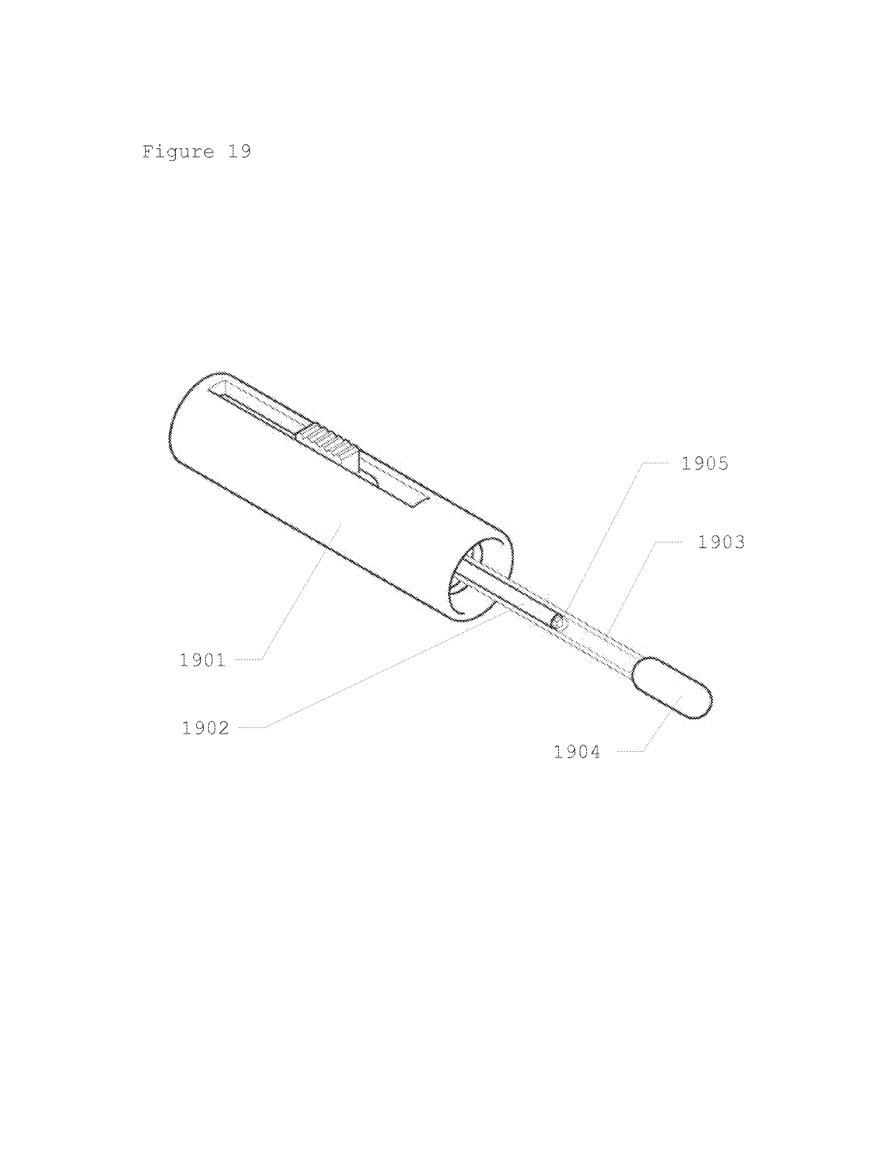

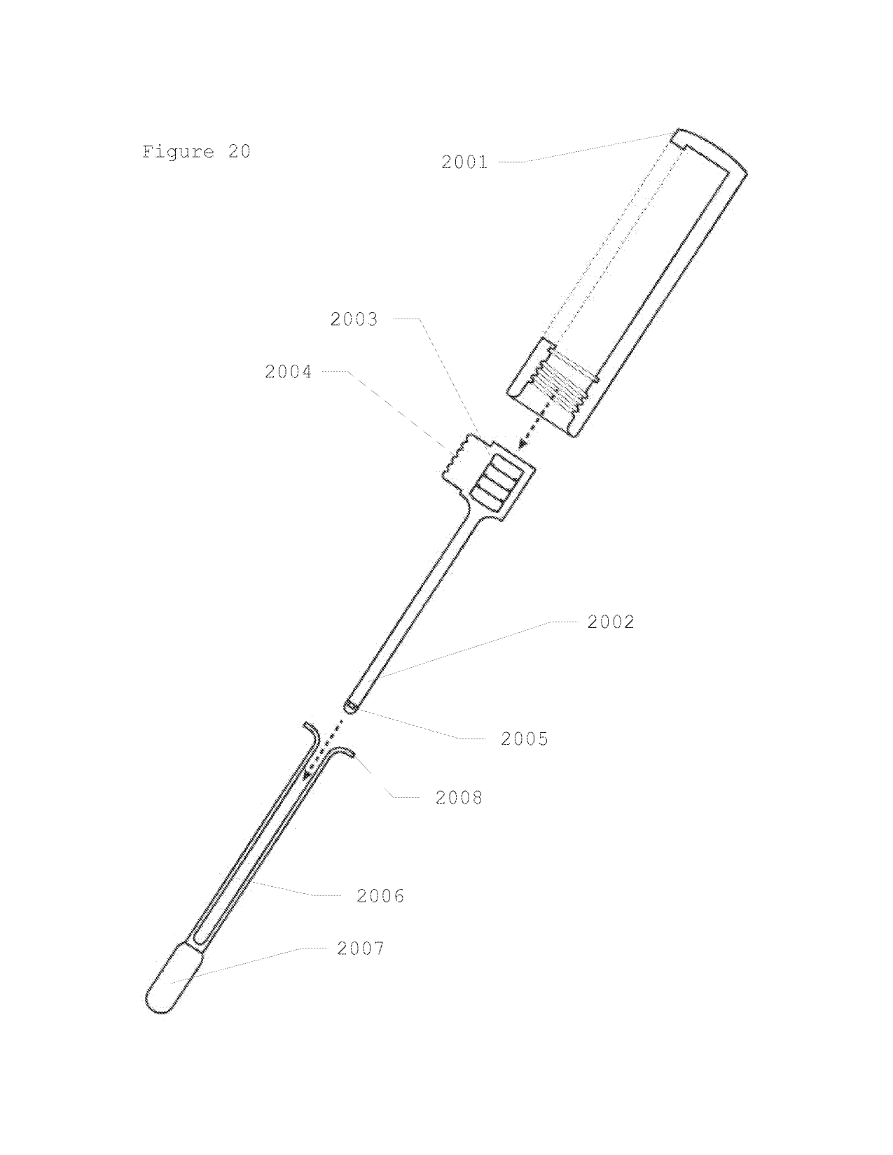

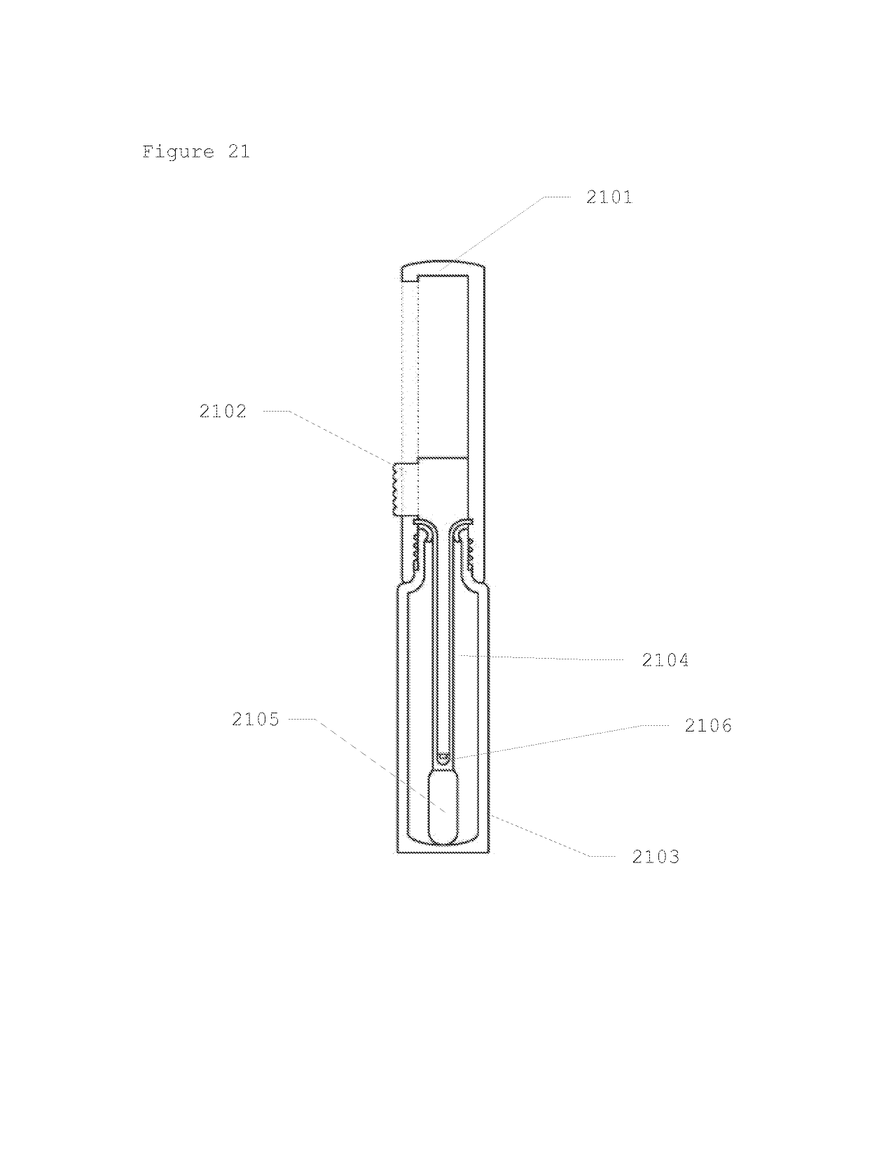

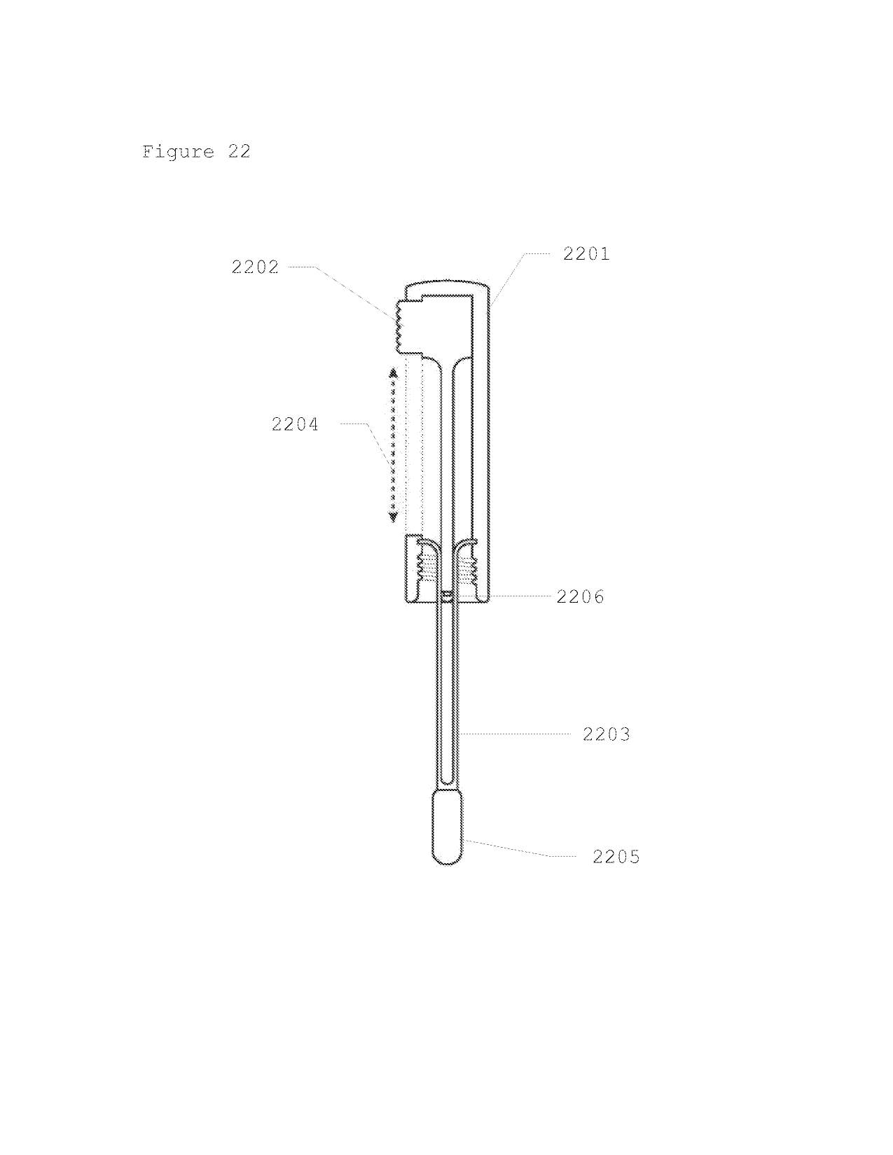

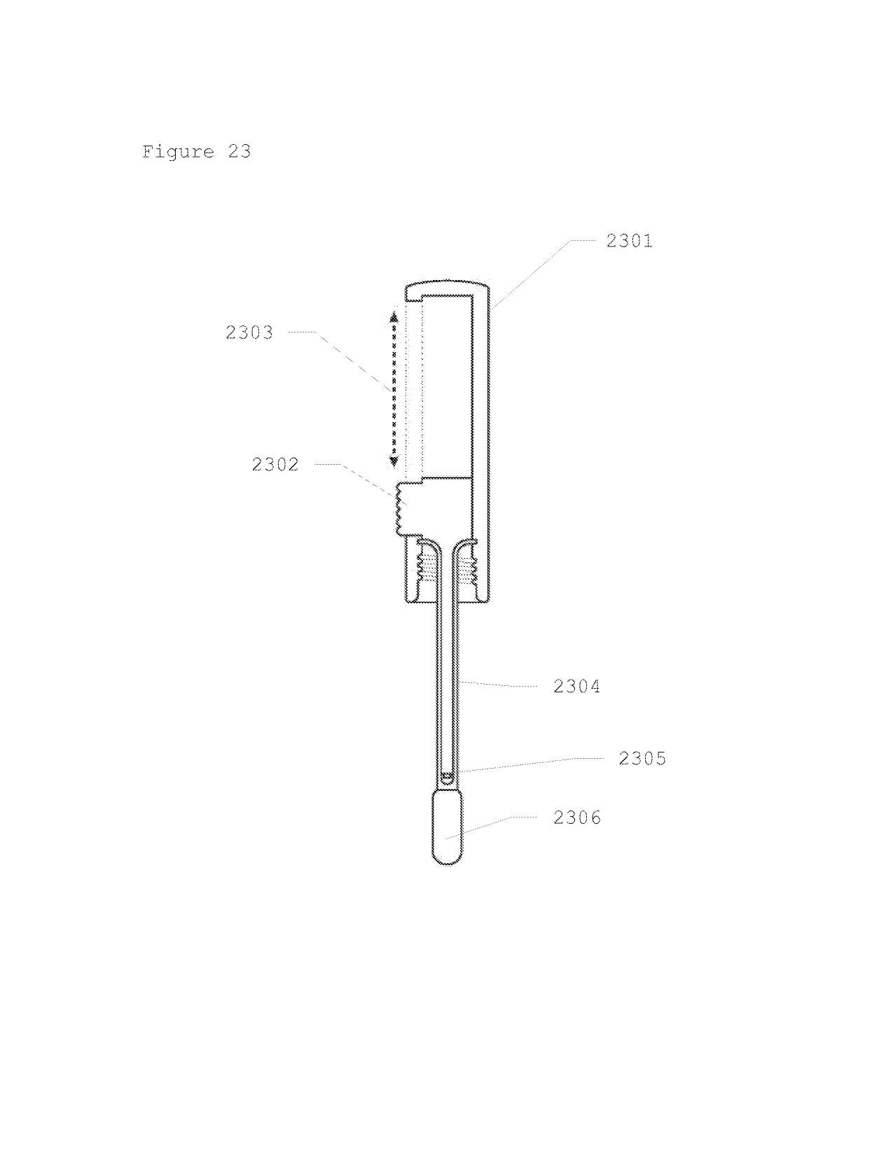

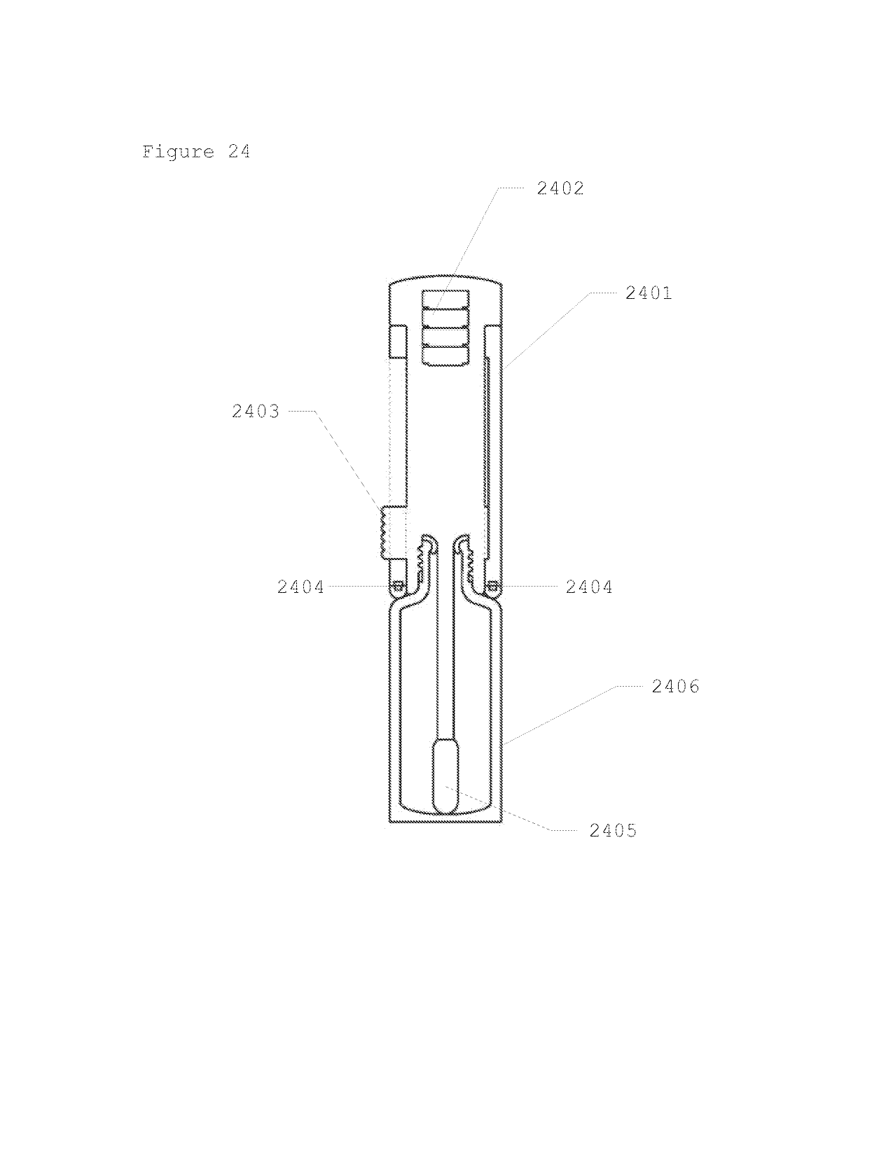

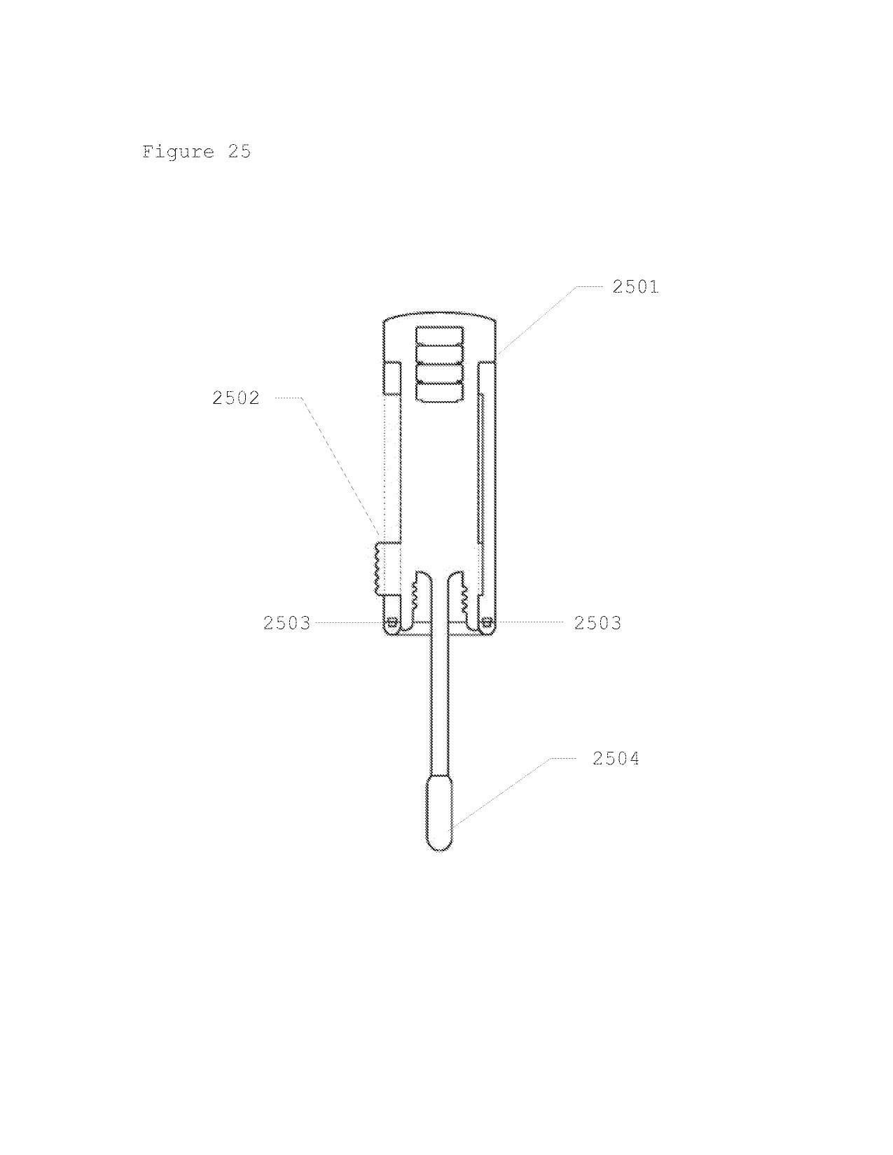

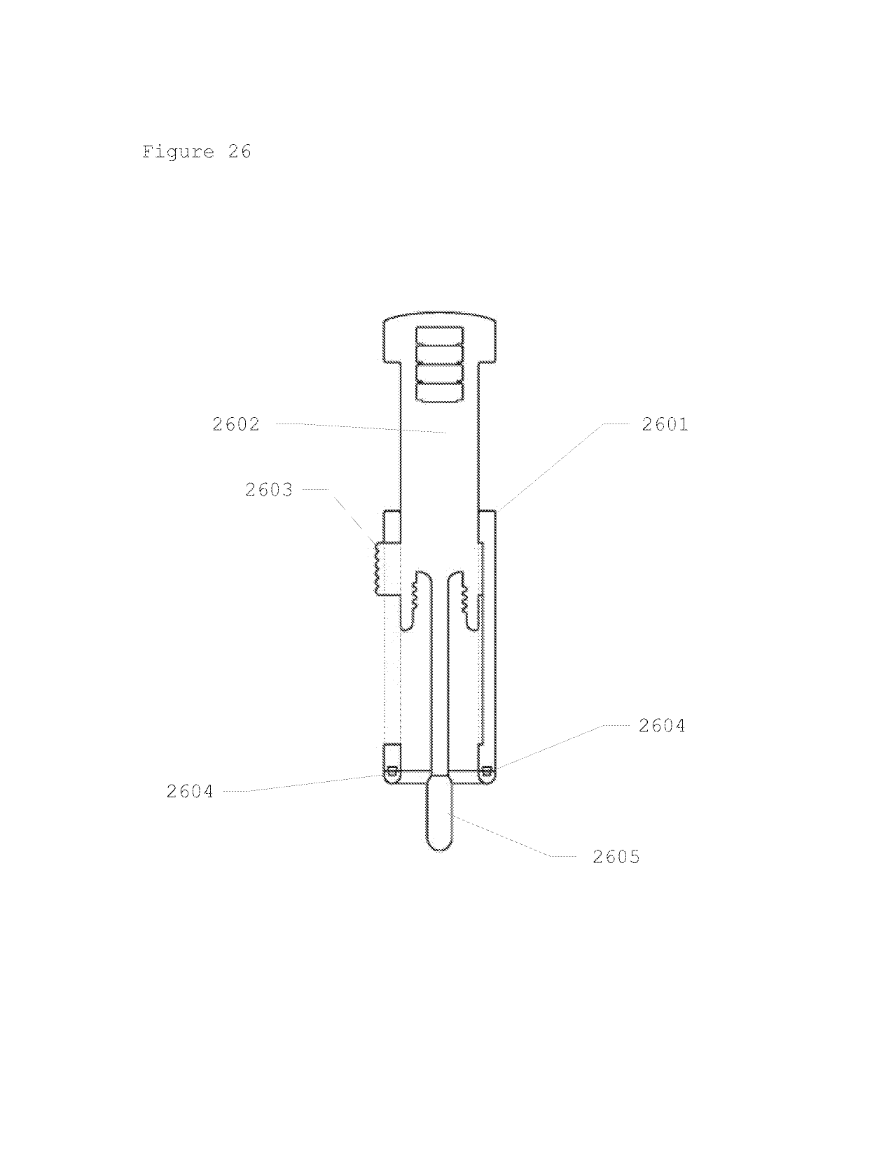

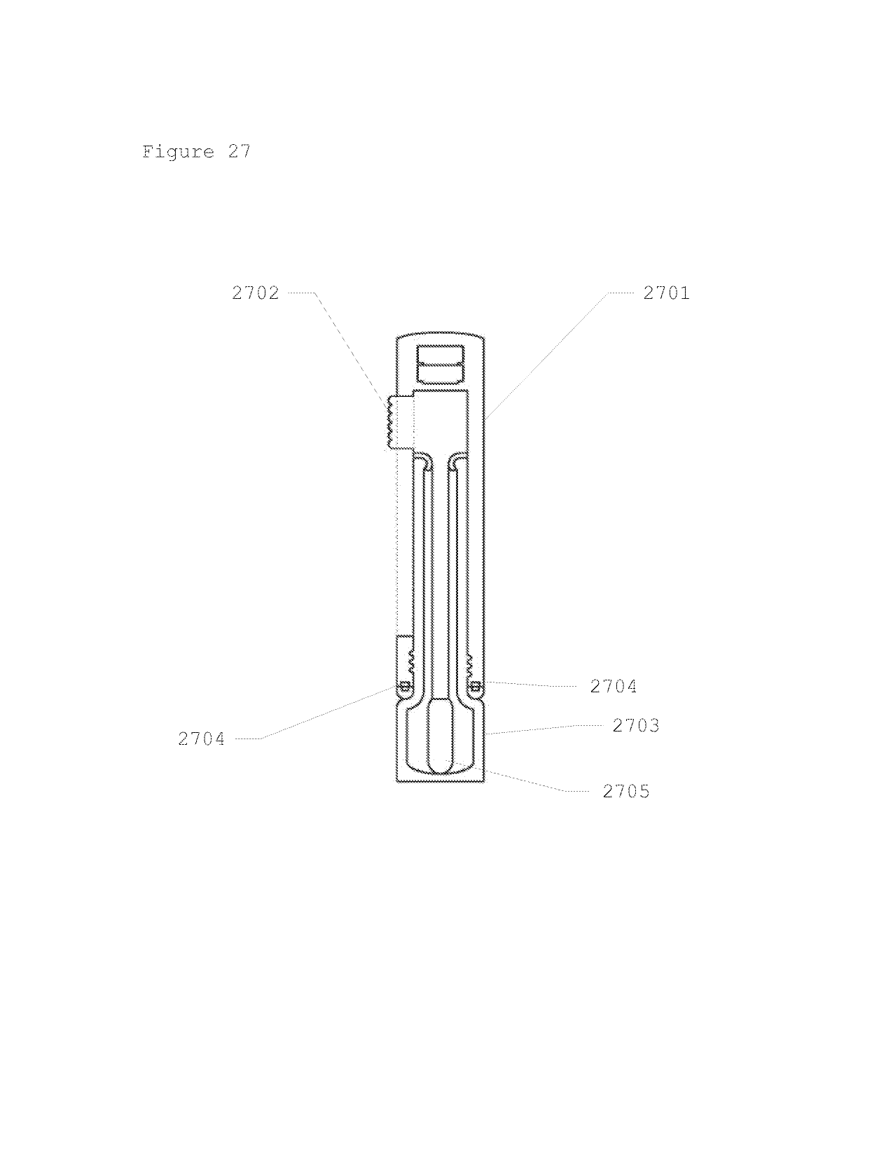

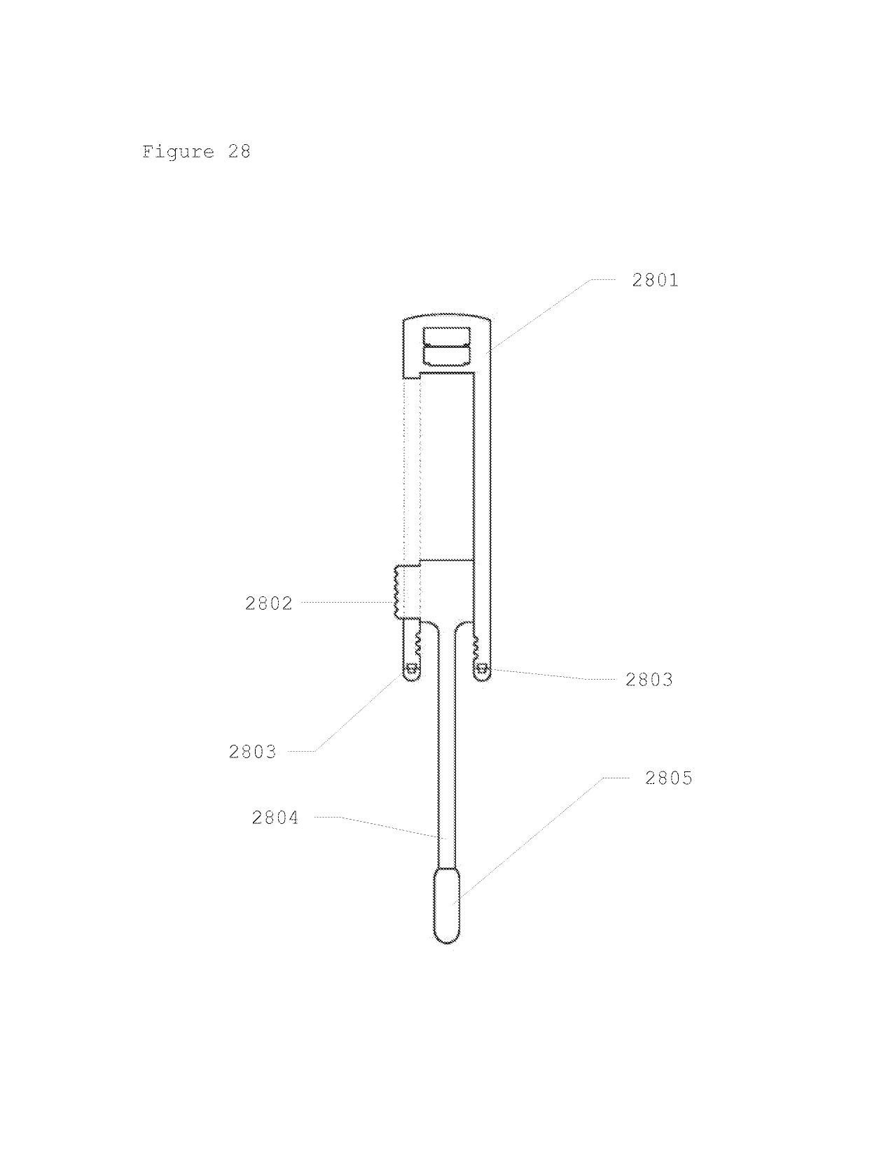

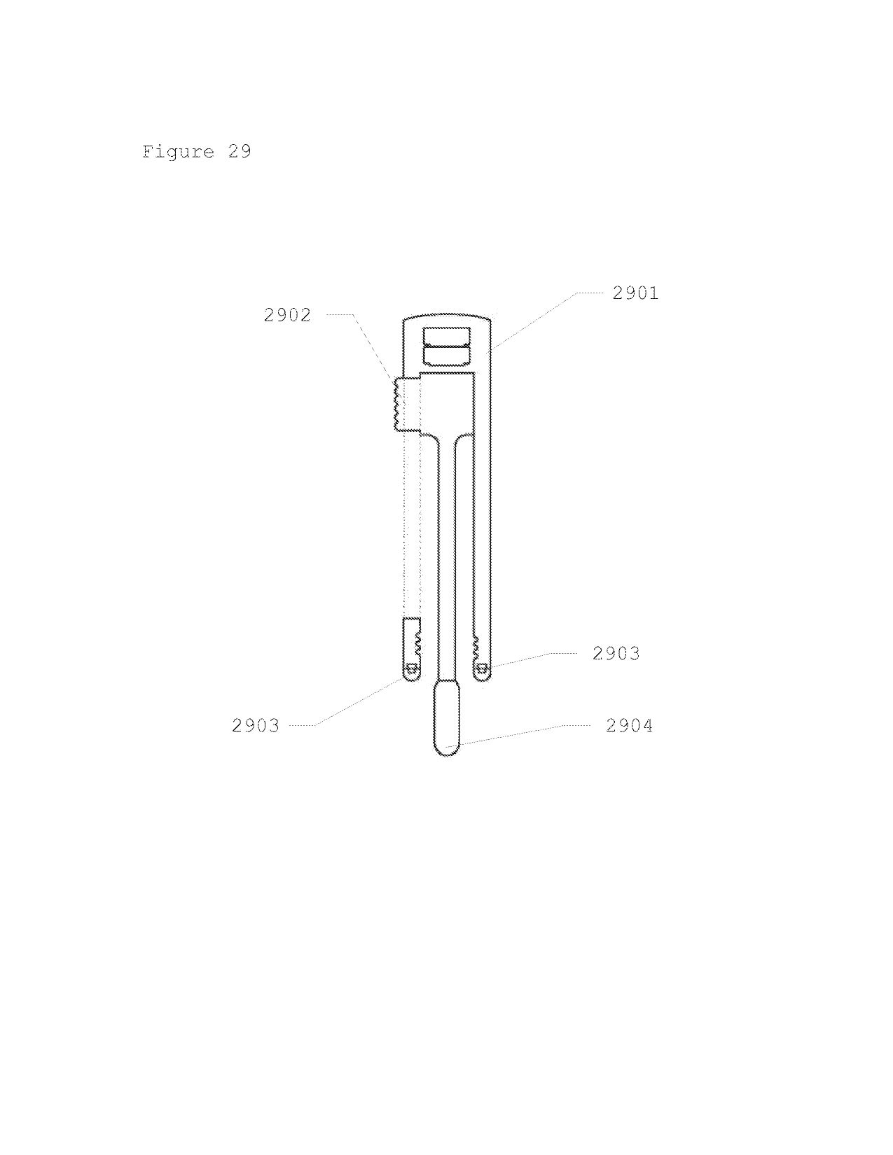

### BRIEF DESCRIPTION OF THE DRAWINGS

<FIG. 1> Twisting type applicator cap with LED light source moving along interior of hollow applicator tube.

<FIG. 2> Isometric view showing twisting type applicator portions disassembled.

<FIG. 3> Twisting type applicator cap with LED light source along interior of hollow applicator tube, shown attached to the bottle holding the makeup liquid.

<FIG. 4> Identical to <FIG. 3>, but showing hollow and solid portions of applicator device.

<FIG. 5> Twisting type applicator cap with LED light source along interior of hollow applicator tube, showing path of motion of LED light source, with LED light source in the farthest position away from applicator tip

<FIG. 6> Identical to <FIG. 5> but showing hollow and solid portions of applicator cap.

<FIG. 7> Twisting type applicator cap with LED light source along interior of hollow applicator tube, showing LED light source in position closest to applicator tip.

<FIG. 8> Identical to <FIG. 7>, but showing hollow and solid portions of applicator cap.

<FIG. 9> Exterior view of twisting action type applicator cap.

<FIG. 10> Example of applicator tip variations.

<FIG. 11> Twisting type applicator cap with moving LED light source mounted axially on end of applicator cap.

<FIG. 12> Twisting type applicator cap with moving LED light source mounted axially on end of applicator cap, shown attached to makeup liquid bottle.

<FIG. 13> Twisting type applicator cap with moving LED light source mounted axially on end of applicator cap, with LED light source in farthest away position from applicator tip.

<FIG. 14> Twisting type applicator cap with moving LED light source mounted axially on end of applicator cap, with LED light source in closest position to applicator tip.

<FIG. 15> Twisting type applicator cap with stationary LED light source mounted axially on end of applicator cap, with moveable applicator tip.

<FIG. 16> Twisting type applicator cap with stationary LED light source mounted axially on end of applicator cap, with moveable applicator tip. Shown with cap attached to makeup liquid bottle.

<FIG. 17> Twisting type applicator cap with stationary LED light source mounted axially on end of applicator cap, with moveable applicator tip. Shown with LED light source in farthest away position from applicator tip.

<FIG. 18> Twisting type applicator cap with stationary LED light source mounted axially on end of applicator cap, with moveable applicator tip. Shown with LED light source in closest position to applicator tip.

<FIG. 19> Sliding type applicator cap with moveable LED light source within hollow applicator tube.

<FIG. 20> Isometric view of sliding type applicator cap, disassembled.

<FIG. 21> Sliding type applicator cap with moveable LED light source within hollow applicator tube. Shown attached to liquid makeup bottle.

<FIG. 22> Sliding type applicator cap with moveable LED light source within hollow applicator tube, with LED light source in farthest position from applicator tip.

<FIG. 23> Sliding type applicator cap with moveable LED light source within hollow applicator tube, with LED light source in closest position to applicator tip.

<FIG. 24> Sliding type applicator cap with moveable LED light source mounted axially on cap. Shown attached to liquid makeup bottle.

<FIG. 25> Sliding type applicator cap with moveable LED light source mounted axially on cap. Shown with LED light source in farthest away position from applicator tip.

<FIG. 26> Sliding type applicator cap with moveable LED light source mounted axially on cap. Shown with LED light source in closest position to applicator tip.

<FIG. 27> Sliding type applicator cap with stationary LED light source mounted axially on cap, with moveable applicator tip. Shown attached to liquid makeup bottle.

<FIG. 28> Sliding type applicator cap with stationary LED light source mounted axially on cap, with moveable applicator tip. Shown with LED light source in farthest away position from applicator tip

<FIG. 29> Sliding type applicator cap with stationary LED light source mounted axially on cap, with moveable applicator tip. Shown with LED light source in closest position to applicator tip.

### DETAILED DESCRIPTION OF THE INVENTION

As detailed, the Makeup Applicator with Moveable Light. Source device provides a mechanism to provide a targeted, bright but diffused LED light source to the precise point of makeup application, and allows for the said application of makeup to occur in low light conditions. Previous patents have provided mechanisms to attach a lighting source to a makeup applicator device, but none have provided the capability to move the light source to the precise targeted area necessary to provide illumination to the makeup application process. Specifically, U.S. Pat. No. 6,789,972 (Nadel) provides for illumination of a makeup applicator wand, and U.S. Pat. No. 7,712,914 (Levy) provides for a light source to be mounted onto the cap of a makeup applicator device. However, none of these prior designs embodies the concept of moving the light source closer to the precise point of makeup application, which is the primary claim of this application.

<FIG. 1> depicts an exterior view of the variation of this invention that provides for a twist type applicator cap that causes the LED lighting source to be moved within a hollow wand to which the makeup applicator tip is attached. 102 shows the exterior casing of the applicator tip, with 101 being the portion of the exterior casing that can be twisted to move the LED light source 104 closer to and farther away from the applicator tip 105 within the hollow applicator want 103. <FIG. 1> shows the LED light source to be placed halfway between the closest and farthest away points from the applicator tip.

<FIG. 2> shows an isometric view of the twist type applicator cap with the LED light source moveable within the hollow applicator want. <FIG. 2> shows the components of this twist type applicator cap, disassembled into its various components. 201 shows the twist portion of the applicator cap, into which the moveable LED light source 202 is mounted. The LED light source 203 is shown at the end of this component 202, and powered by the built-in batteries housed in the same component in 203. The arrow leading away from the LED light source 204 depicts the light source being moved into the hollow wand 205. The light source 204 can be moved to the point in the hollow wand tube where is can be immediately next to the applicator tip 206. The combined assembly of 201, 202, and 205 are mounted into the exterior casing 207, with 208 showing the twisting gear mechanism that allows the LED lighting source to be moved within the hollow makeup applicator wand.

<FIG. 3> shows the fully assembled and complete Makeup Applicator with Moveable Light Source device, in the twist type variant. 301 shows the applicator cap, with 302 showing the portion that can be twisted to move the LED light source 307 within the hollow applicator wand tube 305 using the mechanism shown in 303 as 302 is twisted. The applicator cap is shown attached to the liquid makeup bottle 304. 306 is a depiction of the battery power source attached to one end of the applicator wand, with the other end of the applicator wand being attached to a applicator tip 308.

<FIG. 4> is identical to <FIG. 3> but depicting the hollow (clear) and solid (thatched) sections of the assembly. 401 depicts the applicator cap, attached to the liquid makeup bottle 402. The thatched sections of the figure 403 are solid, whereas the clear sections of the figure shown in 404 show the hollow sections of the apparatus.

<FIG. 5> shows the twist type variant to the Makeup Applicator with Moveable Light Source device, with the LED light source in the farthest away position from the applicator tip. 501 is the exterior casing of the applicator cap, with 502 showing the portion that can be twisted to move the LED light source. 503 shows the mechanism to which the LED light source 506 is attached, powered by the batteries in 504, and made moveable by the mechanism in 505 as the top portion of the cap is twisted. The arrow in 507 depicts the range of motion of the LED light source as the cap is twisted, with 508 being the point to which the LED light source can be moved where it will be closest to the makeup applicator tip 509.

<FIG. 6> is identical to <FIG. 5> except that it shows the hollow (clear) and solid (thatched) sections of the applicator cap. 601 depicts the exterior housing of the applicator cap. The solid sections are shown in 602, and the hollow sections are depicted by the clear sections in 603.

<FIG. 7> shows the twist type variant to the Makeup Applicator with Moveable Light Source device, with the LED light source in the closest position to the makeup applicator tip. 701 depicts the exterior casing of the applicator cap, with 702 showing the portion that can be twisted to move the LED light source using the mechanism depicted in 704. 703 shows the range of motion of the LED light source within the hollow applicator wand. 708 depicts the apparatus attached to the LED light source 706, using battery power source 705, allowing the LED light source to be brought closest to the applicator tip 707.

<FIG. 8> is identical to <FIG. 7>, except that the hollow (clear) and solid (thatched) sections are clearly delineated. 801 depicts the exterior casing of the makeup applicator cap, 802 shows the hollow sections, and 803 depicts the solid sections of the device.

<FIG. 9> shows an exterior view of the twist type variant of the Makeup Applicator with Moveable Light Source device. 901 depicts the exterior casing, with 902 showing the portion of the cap that can be twisted to move the LED light source 903 within the hollow applicator wand tube, allowing it to be move closest to the applicator tip 904. 905 is a concentric view of the applicator tip, looking straight into the applicator cap from the bottom of the applicator cap, from the applicator tip end 904.

<FIG. 10> is an example of two variations on the applicator tip that can be provided. 1001 shows a brush type applicator tip while 1002 shows a solid, sponge type applicator tip. Both are used for different types of makeup application.

<FIG. 11> shows the twist type variant of the Makeup Applicator with Moveable light source device. In this variation, the moveable LED light source is mounted axially on the bottom of the applicator cap 1101 itself, which can be moved up and down by twisting the portion of the cap at 1102. As the cap is turned, the exterior casing holding the LED light source moves closer to the applicator tip 1103.

<FIG. 12> depicts the twist type variant of the Makeup Applicator with Moveable Light Source device where the moveable LED light source is mounted axially on the bottom of the applicator cap 1201 itself, powered by the portable battery supply at 1202. The applicator cap is shown attached to the liquid makeup bottle 1203. The wand 1204 in this variation is stationary, while twisting the cap allows the LED lighting source 1206 to move closer to or farther away from the applicator tip 1205.

<FIG. 13> is a depiction of the twist type variation described in <FIG. 12> but showing only the applicator cap, with the LED lighting source 1303 in the farthest away position from the applicator tip 1304. 1301 again shows the exterior casing of the applicator cap, and 1302 depicts the portable battery source for the LED lighting source at 1303.

<FIG. 14> is also a variant of the twist type applicator cap described in <FIG. 12> but again only showing the applicator cap. <FIG. 14> depicts the LED light source in its closest position to the applicator tip. The exterior casing 1401 is moved by twisting the top portion of the applicator cap, which slides down around the interior assembly 1402 using the mechanism shown. The LED lighting source 1404 is powered by the battery supply 1403 as it travels closer to the applicator tip mounted to the end of the wand 1405.

<FIG. 15> is a twist type variant of the Makeup Applicator with Moveable Light Source device, but where the LED light source is stationary and the twist type mechanism allows the makeup applicator wand no travel closer no or farther away from the applicator tip. 1501 depicts the exterior casing of the applicator cap, where 1502 can be twisted to cause motion in the applicator wand 1504, allowing it to move closer to or farther away from the LED light source 1503.

<FIG. 16> again shows the twist style variant of the Makeup Applicator with Moveable LED Light Source device, with the applicator cap attached to the liquid makeup bottle 1607. 1601 shows the exterior casing of the applicator cap, with 1602 being the portion of the cap that can be twisted to move the applicator wand closer to or farther away from the LED lighting source 1605, which is powered by the portable battery supply at 1603. The movement is provided by the mechanism depicted in 1604 as the cap 1602 is twisted, moving the applicator wand 1606 closer to or farther away from the LED light source.

<FIG. 17> shows the applicator cap from <FIG. 16>, with the LED lighting source in the farthest away position from the applicator tip. 1701 shows the exterior casing, with 1702 depicting the portion of the cap that can be twisted to move the applicator wand 1705 closer to or farther away from the stationary LED lighting source 1706. The LED lighting source is powered by the portable battery supply shown in 1703, with the movement of the wand 1705 provided by the mechanism shown in 1704.

<FIG. 18> shows the applicator cap from <FIG. 16> but with the LED light source in the closest position to the applicator tip. 1801 depicts the exterior casing of the applicator cap, with 1802 being that portion of the cap that can be twisted to move the applicator wand 1804 and applicator tip 1806 closer to or farther away from the LED light source 1805. Again, the illumination of the LED light source is provided by the portable battery supply at 1803.

The remaining figures depict sliding style variations of the Makeup Applicator with Moveable Lighting Source device. <FIG. 19> shows an exterior view of the sliding variation of the applicator cap, with 1901 depicting the exterior casing of the applicator cap. This variant shows the version where the LED lighting source moves within the hollow applicator wand. As the sliding mechanism in 1902 is moved, the LED lighting source 1905 moves within the hollow makeup applicator wand 1903, closer to or farther away from the applicator tip 1904.

<FIG. 20> shows an isometric view of the applicator cap, in the sliding type variation where the LED lighting source can be moved inside of the hollow applicator wand. <FIG. 20> shows the components of this variation, disassembled. 2001 shows the exterior casing of the applicator cap. The LED lighting source apparatus 2002 can be moved using the sliding mechanism 2004. The LED lighting source 2005 is powered by the portable battery supply 2003, and 2008 depicts the range of motion that allows the LED lighting source to travel, within the hollow applicator wand tube 2006, closer to or farther away from the applicator tip 2007.

<FIG. 21> shows a slide type variation of the Makeup Applicator with Moveable Light Source device, with the applicator cap attached to the liquid makeup bottle 2103. This variant depicts the version whereby the LED lighting source can move within the hollow applicator wand tube. 2101 depicts that exterior casing of the applicator cap. As the sliding mechanism 2102 is moved, the LED lighting source at 2106 can be moved within the hollow applicator wand 2104 closer to or farther away from the applicator tip at 2005.

<FIG. 22> shows the applicator cap from the variation described in <FIG. 21>, with the LED lighting source in the farthest away position from the applicator tip. 2201 depicts the exterior casing of the applicator cap. As the sliding mechanism in 2202 is moved, depicting by the range of motion arrows 2204, the LED light source 2206 moves closer to or farther away from the applicator tip 2205 within the hollow applicator wand tube 2203.

<FIG. 23> shows the applicator cap from the variation described in <FIG. 21> with the LED lighting source in the closest position to the applicator tip. 2301 depicts the exterior casing of the applicator cap. As the sliding mechanism 2302 is moved along the arrows showing the range of motion 2303, the lighting source 2305 can be moved closer to or farther away from the applicator tip 2306 inside the hollow makeup applicator wand tube 2304.

<FIG. 24> is another version of a sliding mechanism type variant of the Makeup Applicator with Moveable Light Source device. This variant has the moveable LED light source mounted axially on the end of the applicator cap closest to the applicator tip. 2401 depicts the exterior casing of the applicator cap, attached to the liquid makeup mottle 2406. The LED lighting source 2404, which is powered by the portable battery supply at 2402, moves closer to or farther away from the applicator tip attached to the end of the applicator wand 2405 as the sliding mechanism in 2403 is moved.

<FIG. 25> shows only the applicator cap from the variant described in <FIG. 24>, with the LED lighting source in its farthest away position from the applicator tip. 2501 depicts the exterior casing of the applicator cap. As the sliding mechanism in 2502 is moved, the applicator wand 2504 moves closer to or farther away from the LED lighting source 2503.

<FIG. 26> shows only the applicator cap from the variant described in <FIG. 24>, with the LED lighting source in its closest position to the applicator tip. 2601 shows the exterior casing of the applicator cap. As the sliding mechanism 2603 is moved, the exterior casing can slide up or down around the interior assembly 2602, with the LED lighting source 2604 moving closer to or farther away from the applicator tip 2605.

<FIG. 27> shows another version of a sliding mechanism variant of the Makeup Applicator with Moveable Light Source. In this version the LED light source is mounted axially on the end of the applicator cap closest to the applicator wand. The LED light source in this version is stationary, and the wand tube can be moved to be closer to or farther away from the LED lighting source. 2701 depicts the exterior casing of this variant of the applicator cap, attached to the liquid makeup bottle 2703. As the sliding mechanism in 2702 is moved, the applicator tip 2705 is moved closer to or farther away from the LED lighting source 2704.

<FIG. 28> shows only the applicator cap from the variation shown in <FIG. 27>, with the applicator tip in the farthest away position from the LED lighting source. 2801 depicts the exterior casing of the applicator cap. As the sliding mechanism 2802 is moved, the applicator wand 2804 and applicator tip 2805 are moved closer to or farther away from the LED light source 2803.

<FIG. 29> shows only the applicator cap from the variation shown in <FIG. 27>, with the applicator tip in the closest position to the LED light source. 2901 shows the exterior casing of the applicator cap. As the sliding mechanism 2902 is moved, the applicator tip 2904 moves closer to or farther away from the LED lighting source 2903.

What is claimed is:

1. The Detachable Cover Apparatus for Compact Fluorescent Light (CFL) Light Bulbs that is the subject of this invention provides a heat resistant, pliable or non-pliable cover that encompasses the fluorescent tube portion of the light bulb partially or in its entirety, and is held in place using a rigid frame structure that applies pressure to the exterior surface(s) of the fluorescent tube. The pliable or non-pliable cover can partially or completely cover the entire surface of the fluorescent tube portion of the light bulb, thereby serving to alter the illumination characteristics of the fluorescent light source. In the case of either full or partial covering of the CFL bulb, the CFL cover of the Detachable Cover Apparatus for Compact Fluorescent Light Bulbs device can be moved up and down along the axis of the light bulb to vary the diffusion or softening effect.

2. In a variation of claim 1, the rigidity of the outside portion of the frame structure holding the shape of a pliable cover as well as the interior portion contacting the fluorescent tubing and holding the entire invention in place, can be designed and weaved into the material itself.

3. In particular embodiments of claims 1 and 2, the pliable or non-pliable cover being of such material to cause the fluorescent light source's illumination to be softened or diffused.

4. In particular embodiments of claims 1 and 2, the pliable or non-pliable cover being of such material to cause the fluorescent light source's illumination color to be altered.

5. In particular embodiments of claims 1 and 2, the pliable or non-pliable cover being of such material to cause the fluorescent light source's illumination to be reflected.
